(19) United States
(12) Patent Application Publication
(10) Pub. No.: US 2014/0172144 A1
(43) Pub. Date: Jun. 19, 2014

(54) System and Method for Determining Surface Defects

(71) Applicant: MITSUBISHI ELECTRIC RESEARCH LABORATORIES, INC., Cambridge, MA (US)

(72) Inventor: Andrei Kniazev, Boulder, CO (US)

(73) Assignee: Mitsubishi Electric Research Laboratories, Inc., Cambridge, MA (US)

(21) Appl. No.: 13/716,670

(22) Filed: Dec. 17, 2012

(51) Int. Cl. G06F 17/50

(52) U.S. Cl. CPC G06F 17/5009
USPC 700/110

(57) ABSTRACT

A method determines a defect on a surface of an object. A symmetric representation of at least part of the object is generated and a pair of unmatched areas between the surface of the object and a surface of the symmetric representation is determined. Next, the defect on the surface of the object is determined based on the pair of unmatched areas.

### FIELD OF THE INVENTION

The invention relates generally to simulation of machining, and more particularly to determining a defect on a surface of a model of an object.

### BACKGROUND OF THE INVENTION

Simulation of numerically controlled (NC) machining is of fundamental importance in computer aided design (CAD) and computer aided manufacturing (CAM). During the simulation, a computer model of an object is edited with a computer representation of an NC machining tool and a set of NC machining tool motions to simulate the machining. The object model and tool representation can be visualized during the simulation to detect potential collisions between parts, such as the object and the tool holder, and to verify the final shape of the object after the simulation. The simulation of the machining of the object creates a virtual surface corresponding to the actual surface of the object to be machined.

The final shape of the object is affected by the selection of the tool and the tool motions. Instructions for controlling these motions are typically generated using the CAM system from a graphical representation of the desired final shape of the object. The motions are typically implemented using numerical control programming language, also known as preparatory code or G-Code, see the following standards RS274D and DIN 66025/ISO 6983.

The G-Code generated by the CAM system may not produce an exact replication of the desired shape. In addition, the movement of the NC tool is governed by motors of the NC machining system, which have limited speeds, ranges of motion, and abilities to accelerate and decelerate, so that the actual tool motions may not exactly follow the NC machining instructions.

Moreover, the CAD model may be erroneous, due to artifacts. If the defects are introduced during the CAD process, then the comparison of the actual object with simulated object does not locate the differences. If the detects are introduced during the simulation, then the comparison between the actual and simulated objects might also be ineffective. For example, the actual and the simulated objects can have differences in scale and accuracy requirements.

Discrepancies between the actual final shape of the object and the desired final shape of the object can be very small, and difficult to see. In some cases, these discrepancies result in undesirable gouges or nicks in the surface of the final shape of the object with sizes on the order of a few micrometers in depth and width, and tens of micrometers in length. These surface defects of the simulated object can lead to non-smooth and non-flat finish of the manufactured object and visually appear as scratches or tiny bumps, barely observable by the eye. Such defects are undesirable and often unacceptable.

The conventional methods for determining defects of a surface of an object fall into two classes. According to the first class of methods, the surface is displayed to an operator for visual inspection. Typically, a set of NC machining instructions is tested by machining a test object made of a softer, less expensive material prior to machining the actual object. The operator finds the surface defects and marks their locations. If the visual inspection of the test object locates undesirable discrepancies in the test object, then the NC machining instructions are modified accordingly. However, such manual testing is time consuming, expensive, and the defects are difficult to see, if at all.

The time required to machine a single test object may be on the order of hours. In addition, several iterations may be required before an acceptable set of NC machining instructions is attained. Thus, it is desirable to test for these discrepancies using computer-based simulation and rendering. Because the NC machining simulator is capable of producing very small defects, e.g., 10s to 100s of microns, in very large simulated parts, e.g., 1000s of millimeters, the problem of locating these small defects is challenging.

The second class of methods determines defects on the surface of the object by analyzing the path of the machining tool during the NC simulation. For example, normal vectors along the path of the tool are analyzed and the defect can be determined based on orientations or rate of change of orientations of the normal vectors, see US patent application 2011/0320023.

However, that method uses the information about the surface only in a small neighborhood around the defect, which may not be optimal for some applications.

### SUMMARY OF THE INVENTION

Various embodiments of the invention are based on a realization that symmetry of an object differs from the symmetry of defects of a surface of the object. Thus, the symmetry, which is global information about the object, can be utilized to detect and remove the defects of the surface of the object.

If the object includes a defect, the comparison between the surfaces of the object and the surface of a symmetric representation of the object determines a pair of unmatched areas of the surfaces, which include the defect. Accordingly, using only global information about symmetry of the object, the defects of the surface of the object can be identified.

Some embodiments of the invention generate multiple symmetric representations of the object to specifically identify the area of the defect. If there is a defect on the surface of this object, then the defect is detected by comparing the area of the surface with its two symmetric representations having the same defect in different, symmetric locations. One embodiment, after detecting the defect, fixes the model of the object to generate a model of the object without the defect on the surface.

Accordingly, one embodiment of the invention discloses a method for determining a defect on a surface of an object. The method includes steps of generating a symmetric representation of at least part of the object; determining a pair of unmatched areas between the surface of the object and a surface of the symmetric representation; and determining the defect on the surface of the object based on the pair of unmatched areas. The steps of the method are performed by a processor.

Another embodiment discloses a method for determining a defect of a surface of an object due to machining the object, wherein the surface is generated from a model of the object by a simulation of the machining. The method includes steps of generating a first symmetric representation of a part of the surface; generating a second symmetric representation of the part of the surface, wherein the first and the second symmetric representations are mutually symmetric; and determining the defect as a common difference between the surface of the object with the first symmetric representation and the second symmetric representation. The steps of the method are performed by a processor.

Yet another embodiment discloses a system for determining a defect of a surface of an object due to machining the object, wherein the surface is generated from a model of the object by a simulation of the machining process. The system includes a processor for determining the defect based on a comparison of the surface of the object with a surface of a symmetric representation of the object.

### BRIEF DESCRIPTION OF THE DRAWINGS

FIG. 1 is an illustration of the realization used by some embodiments of the invention;

FIG. 2 is a block diagram of a method for determining a defect on a surface of an object according to some embodiment;

FIG. 3 is an example of an object with reflective symmetry;

FIG. 4 is a schematic of a model of the object with rotational symmetry;

FIG. 5 is a side view of a model of the object with helical symmetry;

FIG. 6 is an oblique view of a model of the object with pyritohedral symmetry;

FIG. 7 is a an oblique view of a model of the object with translational symmetries;

FIG. 8 is an oblique view of a model of an object with reflective symmetry having segmented part with cylindrical symmetry;

FIG. 9 is a block diagram of a method for determining defects of a surface of the object according to an embodiment of an invention;

FIG. 10 is a schematic of an object milled by ball end milling cutter;

FIG. 11 is a side view of the object milled by the ball end milling cutter;

FIG. 12 is a block diagram of a method for highlighting defects of the surface according to an embodiment of the invention; and

FIG. 13 is a block diagram of an example of an embodiment of the invention.

### DETAILED DESCRIPTION OF THE PREFERRED EMBODIMENT

The embodiments of the invention are based on a realization that symmetry of an object generally differs from the symmetry of defects of a surface of the object. Thus, the symmetry, which is global information about the object, can be utilized to detect and remove the defects of the surface of the object.

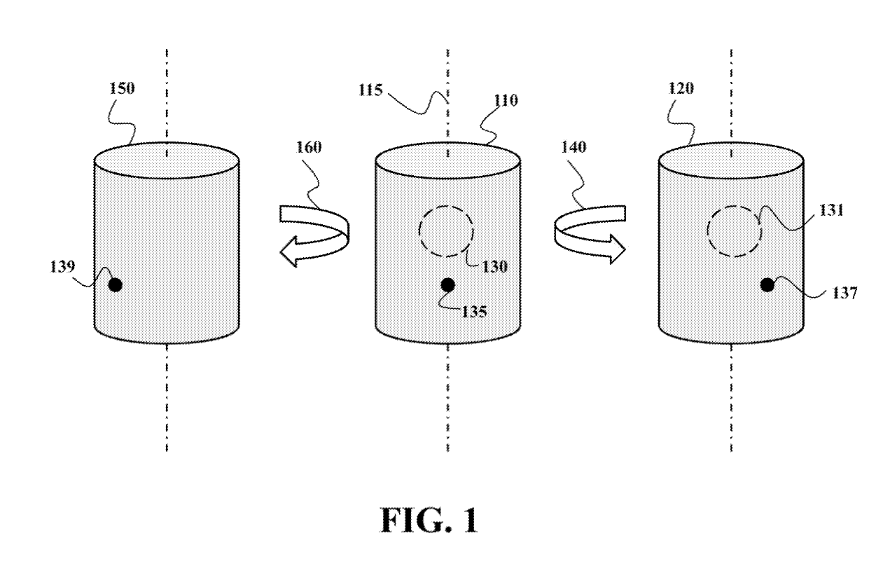

FIG. 1 is a schematic of an illustration of the realization used by some embodiments of the invention. An object, e.g., a cylinder 110, has a rotational symmetry around an axis 115. Rotation 140 of the object 110 around the axis 115 generates a symmetric representation of the object, i.e., a cylinder 120. If the surface of the object 110 has no defects, such as in an area corresponding to a part of the surface 130, then the corresponding part 131 on a surface of the symmetric representation matches the part 130. However, if the surface of the object includes a defect 135, the corresponding parts of the surface of the object and the surface of the symmetric representation do not match, because the defect is rotated to an area 137.

Thus, if the object includes a defect, comparison between the surfaces of the object and the surface of the symmetric representation of the object determines a pair of unmatched areas 135 and 137 of the surfaces. Accordingly, using only global information about symmetry of the object, the defects of the surface of the object can be identified.

However, such comparison can only identify potential areas of the defect. It is unclear whether the defect is in the area 135 or in area 137, because no knowledge is available regarding which of the two areas is defective. For some applications such detection is sufficient and over-inclusivity of the detection of the defect may be preferred.

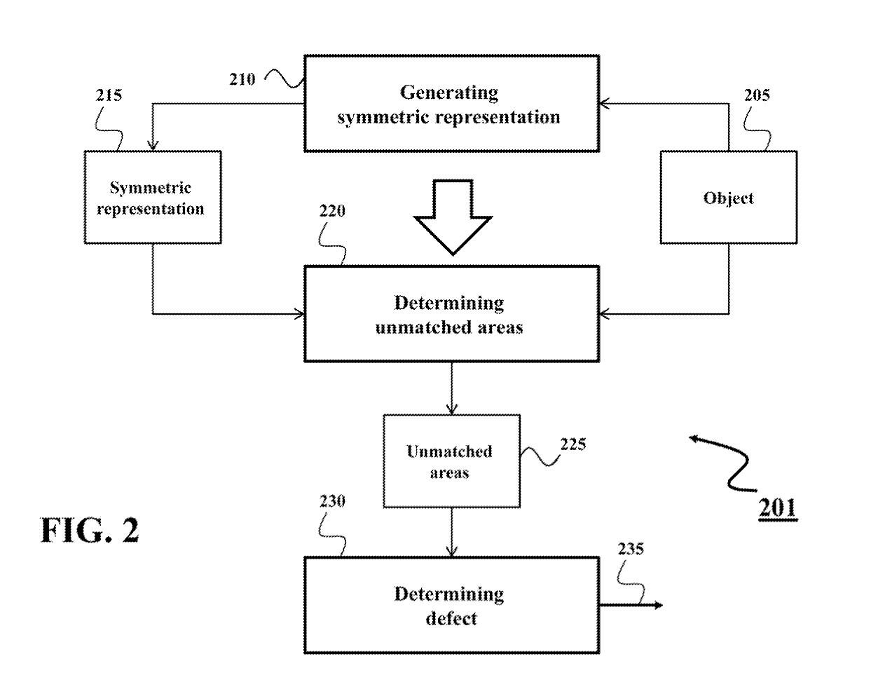

FIG. 2 shows a block diagram of a method for determining a defect on a surface of an object according to one embodiment employing some principles described above. A symmetric representation 215 of at least part of the object 205 is generated. A pair of unmatched areas 225 between the surface of the object and a surface of the symmetric representation is determined 220, and the defect 235 on the surface of the object is determined based on the unmatched areas 230. Steps of the method can be performed by a processor 201.

Some embodiments of the invention generate multiple symmetric representations of the object to uniquely identify the area of the defect. If there is a defect on the surface of this object, then the defect is detected by comparing the area of the surface with its two symmetric representations having the same defect in different, symmetric locations. One embodiment, after detecting the defect, fixes the model of the object to generate a model of the object without the defect on the surface.

For example as shown in FIG. 1, the symmetric representation 120 is a first symmetric representation, and the pair of unmatched areas 135 and 137 is a first pair. One embodiment generates 160 a second symmetric representation 150 of the object. Next, a second pair of unmatched areas 139 and 135 between the surface of the object and a corresponding surface of the second symmetric representation is determined. Comparing the first pair of unmatched areas, i.e., 135 and 137, with the second pair of unmatched areas, i.e., 135 and 139, determines a common unmatched area representing the defect. In this example, this is the area 135.

Various embodiments of the invention acquire information of the symmetry of the objects. Such information may be available from CAD software as a high-level description of the CAD object. Alternatively, the information can be provided, e.g., by an external process or by an operator. In another embodiment, the symmetry is determined from the CAD data by specialized software for symmetry recognition.

At least ideally or by design, the symmetry of the object or part of the object means that the object is identical to its symmetric representation. The symmetric representation is constructed by a geometrical transformation corresponding to the symmetry of the object. Such transformations can include reflections, rotations, translations, or combinations of these basic operations.

For example, the reflection or mirror symmetry of an object in three dimensions is symmetry with respect to reflection of the object using a plane or mirror of symmetry. The reflected image of the object is identical (apart from defects) to the object. Various embodiments of the invention compare a reflective symmetric part of the object to its reflection. Comparing just reflections can be advantageous for fast detection of the defects, e.g., when the requirement is only to highlight two potential defect areas rendered on a display device. However, the comparison is done only to a single symmetric representation, which determines the location on the defect only up to the reflection, so both mutually reflective locations need to be marked.

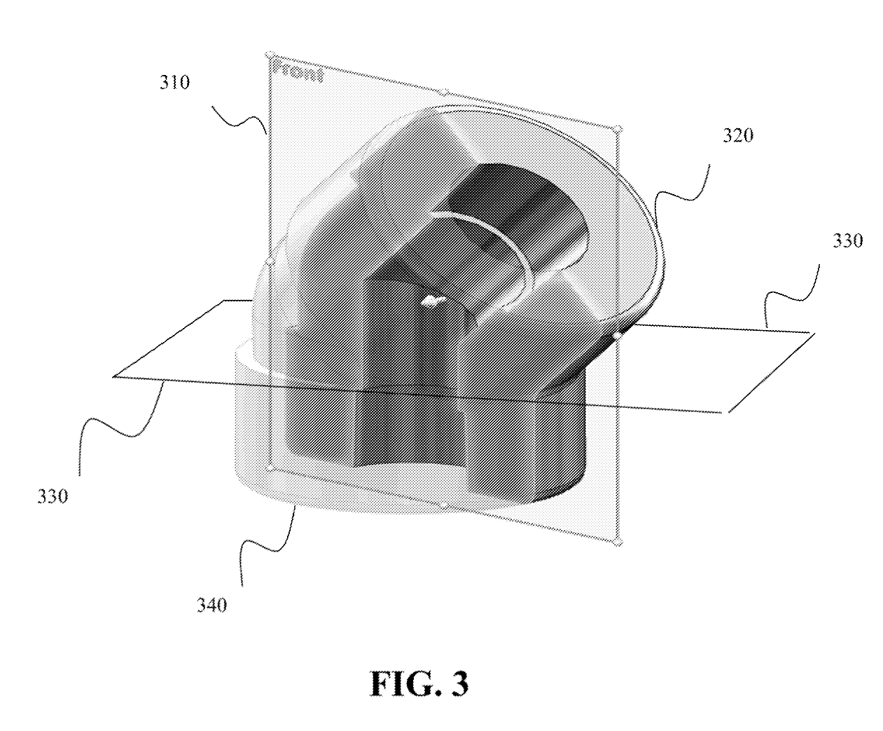

FIG. 3 shows an example of an object 320 with multiple symmetries. First, the object has reflective symmetry, with respect to the plane 310, where the front and the back are reflections of each other. In some embodiments, the symmetric representation of the part of the object is determined by segmenting the object along its corresponding symmetry, e.g., the plane 310.

The front and the back surfaces of the object 320 are mutually symmetric, i.e., the surfaces are symmetric representation of each other. Thus, by comparing the front and the back surfaces of the object, any difference of the surfaces indicates a defect. Accordingly, one embodiment segments a model of the object into a set of mutually symmetric parts including a first mutually symmetric part and a second mutually symmetric part, and compares the mutually symmetric parts to determine the defect. For example, in the embodiments of FIG. 2, the part of the object can be the first mutually symmetric part, and the symmetric representation of the part of the object can be the second mutually symmetric part.

In the example of FIG. 3, a plane 330 cuts out the bottom part 340 of the object. The part 340 has additional cylindrical symmetry. The cylindrical symmetry can provide more information about the part of the object compared to reflective symmetry, because the cylindrical symmetry can be symmetrically parameterized. Such a parameterization allows constructing a virtual ideal symmetric surface. Comparing the actual surface to the ideal surface can locate and fix the surface defects.

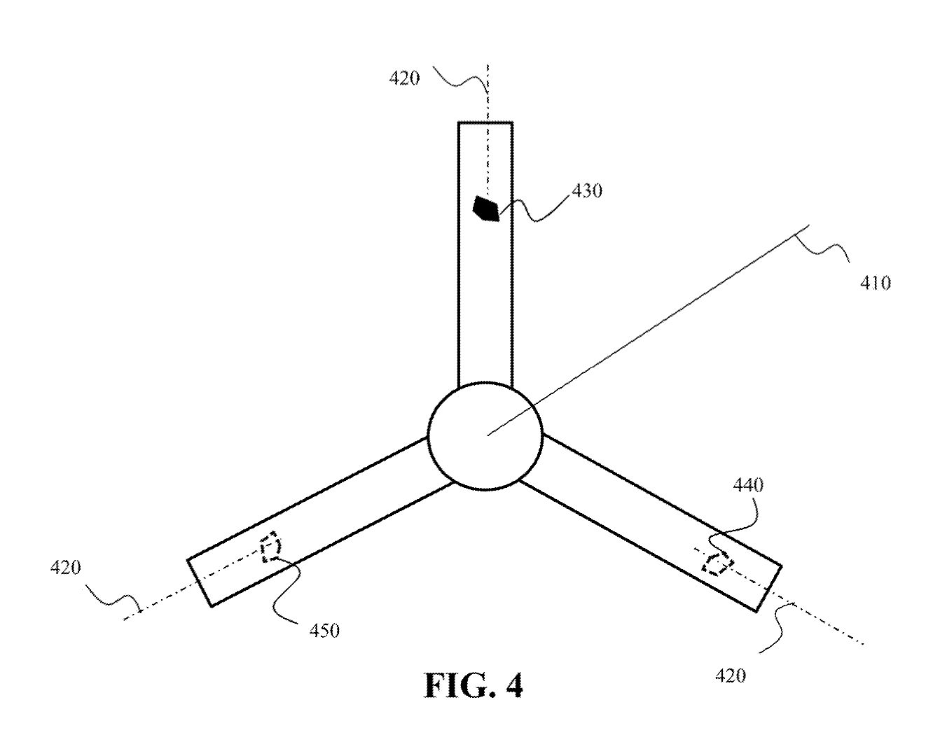

FIG. 4 shows a schematic of an object with rotational symmetry, where the object appears the same after two rotations around the center line 410. This specific rotation symmetry is with an angle 120 degrees between the lines 420. This rotation symmetry is called C3, because the 360 degrees divided by 120 degrees is equal to three. There is a defect 430 of the surface of this object. The embodiments identify the defect, because the area of the defect moves by 120 degrees when the object is rotated. Two turn of the object generates two symmetric representations. Comparing the object with the two symmetric representations determines two pairs of unmatched areas, i.e., a first pair 430 and 440, and a second pair 430 and 450. Such comparison reveals uniquely the exact location attic defect 430. The defect can be removed, e.g., by replacing this erroneous part of the surface with the corresponding piece from one of the two symmetric representations.

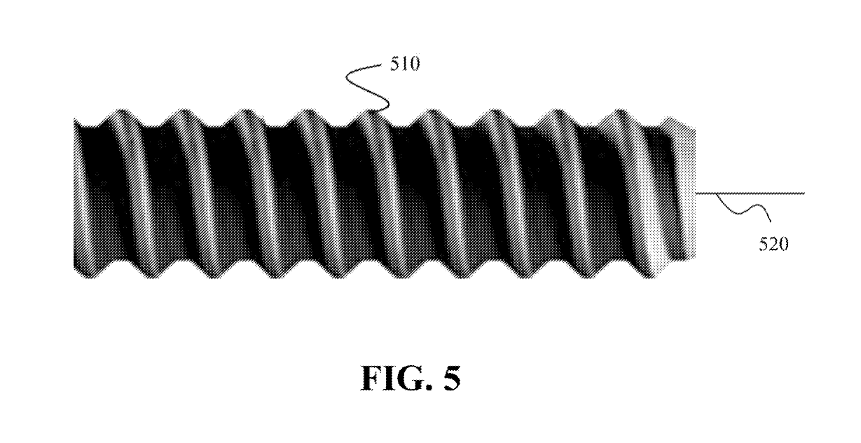

FIG. 5 displays an object with helical symmetry of the central part 510. The helical symmetry is rotational symmetry along with translation along the axis of rotation, the axis 520.

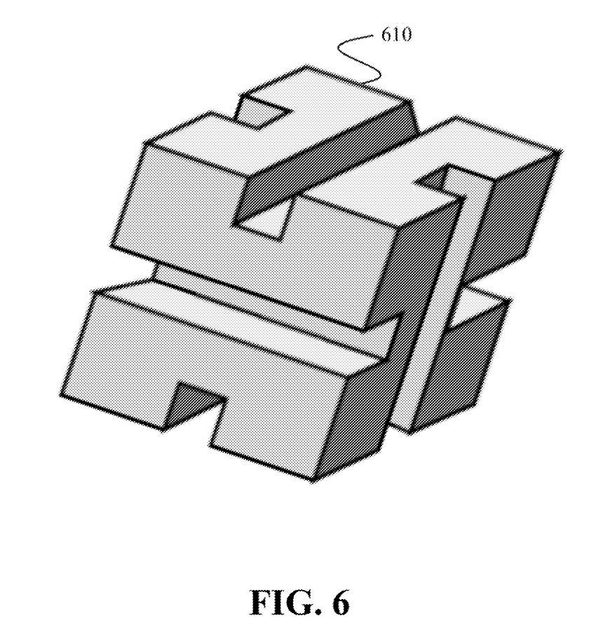

FIG. 6 shows an object 610 with pyritohedral symmetry, formed by the rotations of orders two and three and the reflections in planes parallel to the faces of the cube. This is a particular example of a more general class of symmetries, commonly denoted O(3), including a rotation around an axis through the origin, a reflection across a plane through the origin, a roto-reflection (a rotation around the axis followed by a reflection across a plane through the origin), and their combinations. Pyritohedral symmetry involves multiple symmetries, and thus allows the embodiments to uniquely determine the location of the defect and fix the defect.

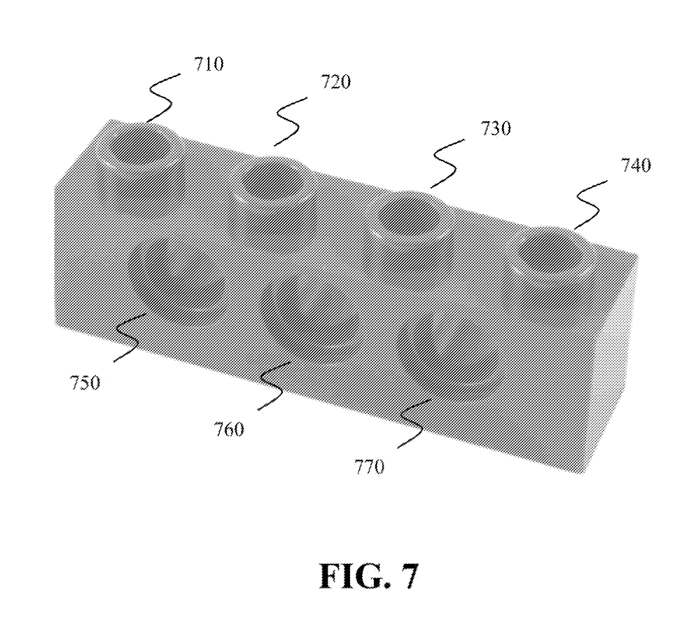

FIG. 7 shows translational symmetries. The top surface of the object has a pattern of the same part repeated four times, 710, 720, 730, and 740, left-to-right. The rest of the object has another translational symmetry, where the same-shaped hole is repeated three times, 750, 760, and 770.

In some embodiments, the information about the symmetric patterns of the object is provided. In alternative embodiments, the symmetry of the object is determined automatically, or with operator assistance. For example, one embodiment segments the object as a union of the symmetric shapes with known symmetries. Examples of such shapes are basic shapes, such as spheres, cubes, etc.

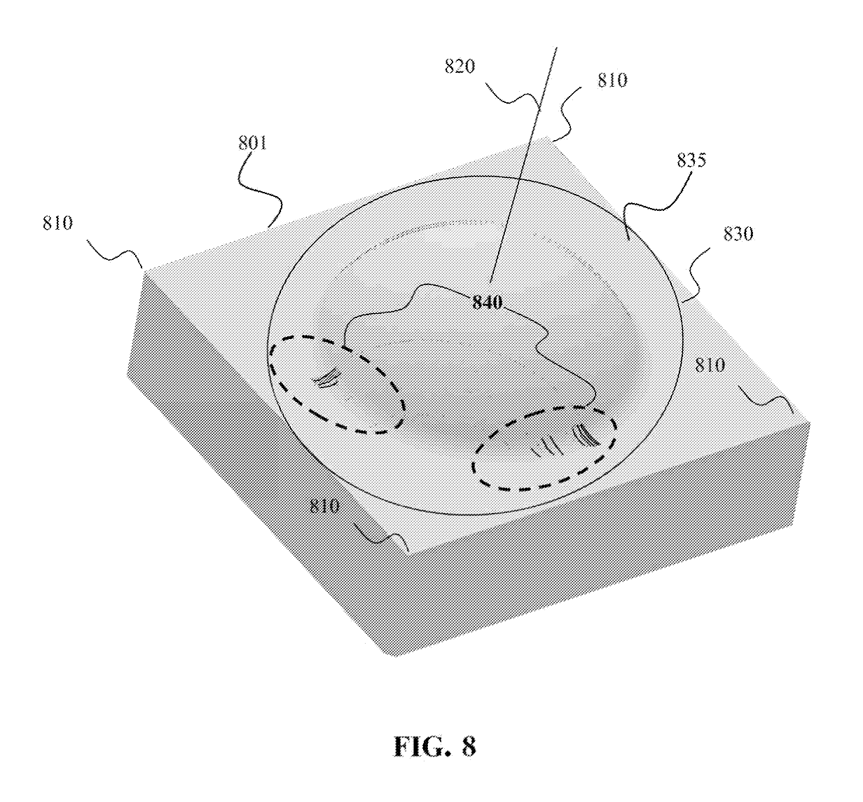

FIG. 8 shows a diagram of an object 801 with multiple reflection symmetries. In addition, the object 810, apart from the corners 810, has a cylindrical, also called axial, symmetry. Axial symmetry is symmetry around an axis 820, i.e., the object 801 is axially symmetric because its appearance is unchanged when rotated around the axis 820.

Some embodiments segment the object into a plurality of parts including the symmetric part. In this case, the embodiment makes a virtual center circular cut out 830 in order to segment the symmetric part 835 of the object. The segmented part 835 has a cylindrical symmetry. Cylindrical symmetry, compared to reflective symmetry, generates an infinite number of symmetric representations, i.e., the part 835 can be symmetrically rotated around the axis 820 by any angle. Accordingly, the segmenting allows analyze symmetric parts of the object separately to determine the defects 840. Thus, some embodiments can detect the defect on the surface of the object even if the entire object is not symmetric.

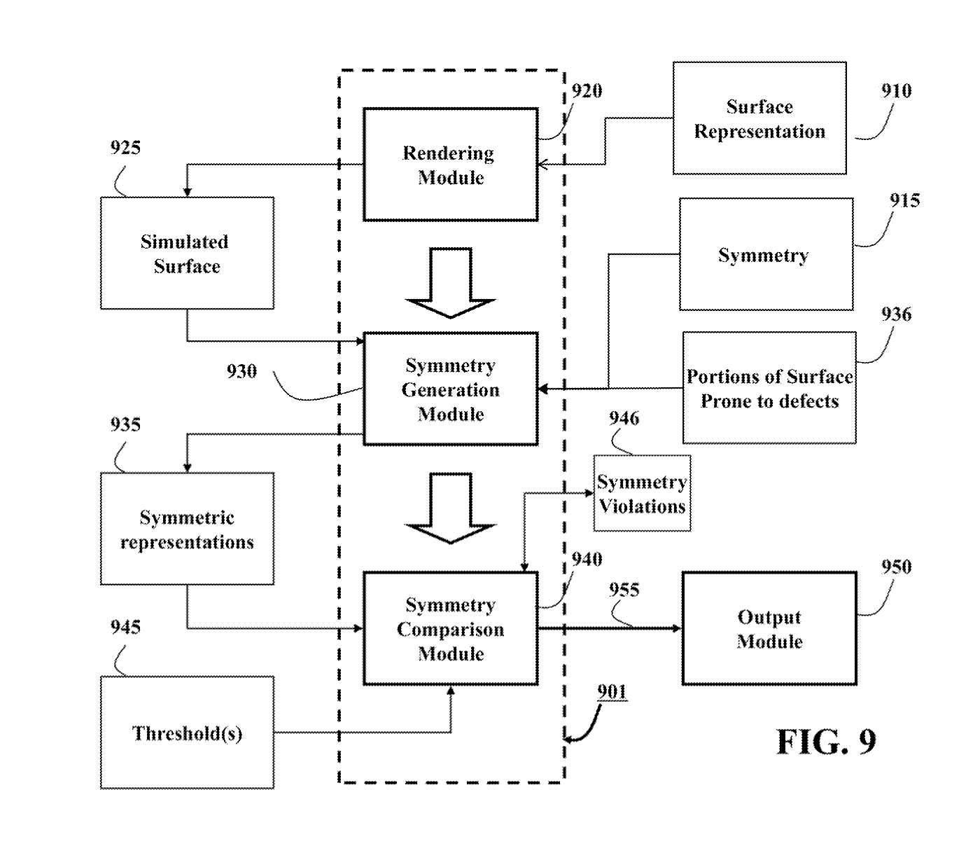

FIG. 9 shows a block diagram of a method for determining defects of the surface of the model of the object using symmetry of at least a part of the object. In various embodiments of the invention, the surface is an entire surface of the object, a segment of the entire surface of the object, a visible surface from a particular point of view, regions of the object having high probability of defects, and/or combinations thereof. In one embodiment, the model of the object is produced from a model of original object based on a set of machining instruction. Steps of the method can be performed by a processor 901.

A surface 925 of the model of the object is simulated by a rendering module 920 based on underlying representation 910 of the surface of the object. The surface symmetry generation module 930 generates symmetric representations 935 of the simulated surface 925 at each pixel of the surface, using the symmetry 915 of the object.

The symmetry comparison module 940 determines difference between the simulated surface 925 and its symmetric representations 935 and compares the difference with one or more thresholds 945 to determine the symmetry violations, i.e., the defects of the surface 946. One embodiment compares the symmetry violations to a minimal threshold, i.e., portions of the surface corresponding to the symmetry violations of the surface with values above the minimum threshold are identified. Additionally or alternatively, another embodiment compares the symmetry violations to a maximal threshold, i.e., portions of the surface corresponding to the symmetry violations of the surface with the values below the maximal threshold are identified.

In various embodiments, the minimal and/or maximal thresholds are determined based on a shape of the original surface, a size of the tool, the machining instructions, and/or a desired accuracy.

The machining includes, but is not limited to, turning, milling, and drilling operations. Depending on the operation, the machining further includes selecting a tool, e.g., a type of the tool such as a single point tool or a multiple-cutting-edge tool, shape, materials, and dimensions of the tools, determining directions of the motion of the tools, the step over distance of the tools, and determining machining instructions for the operation. In turn, the machining instructions include an order of operations and a path for the tool.

The machining controls a desired accuracy of the surface. For example, the step over distance for roughing cuts can be greater than the step over distance for finishing cuts. However, a value of the step over distance is just a one example of controlling the smoothness of the surface by the machining process. Accordingly, several embodiments of the invention determine the minimal and/or the maximal threshold based on the machining process that generates the surface of the object. Similarly, some embodiments determine the thresholds based on the simulation of the machining process that generates the surface of the model of the object.

An output 955 of the method is processed by an output module 950. For example, the output module stores indentified portions of the surface with defects in a memory (not shown). Additionally or alternatively, the output module displays the model of the object on a display device highlighting the portions 840 of the surface with defects, as shown in FIG. 8.

In some embodiments, the simulated surface 925 and its symmetric representations 935 are produced or compared using the normal vectors, as described below.

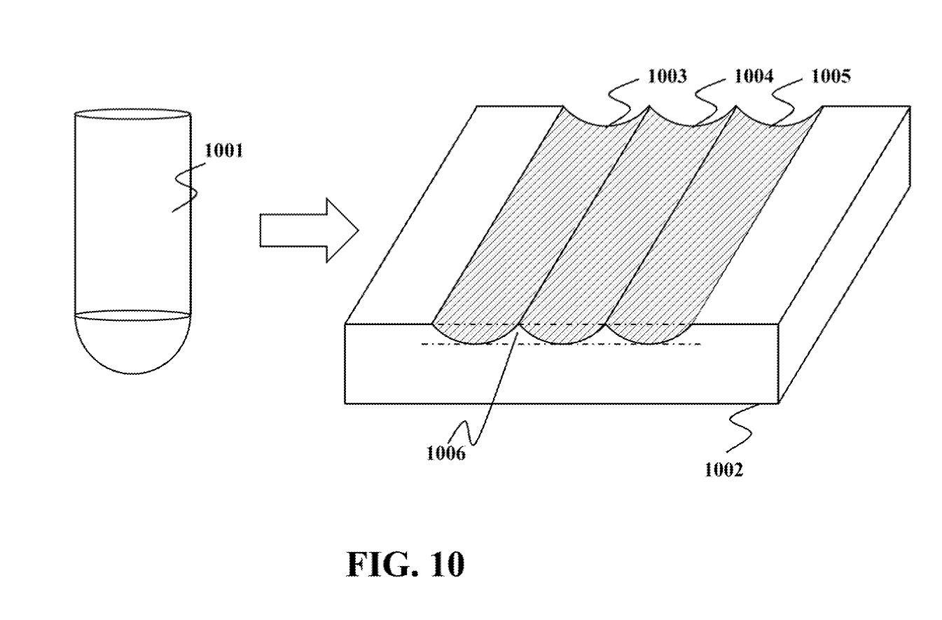

FIG. 10 shows an object 1002 milled by three linear cuts 1003, 1004, and 1005 of the ball end milling cutter 1001 producing semi-cylindrical surfaces. Between each of the cuts, there is a triangular cusp formed by an intersection of each pair of cuts. For example, there is a cusp 1006 between cuts 1003 and 1004.

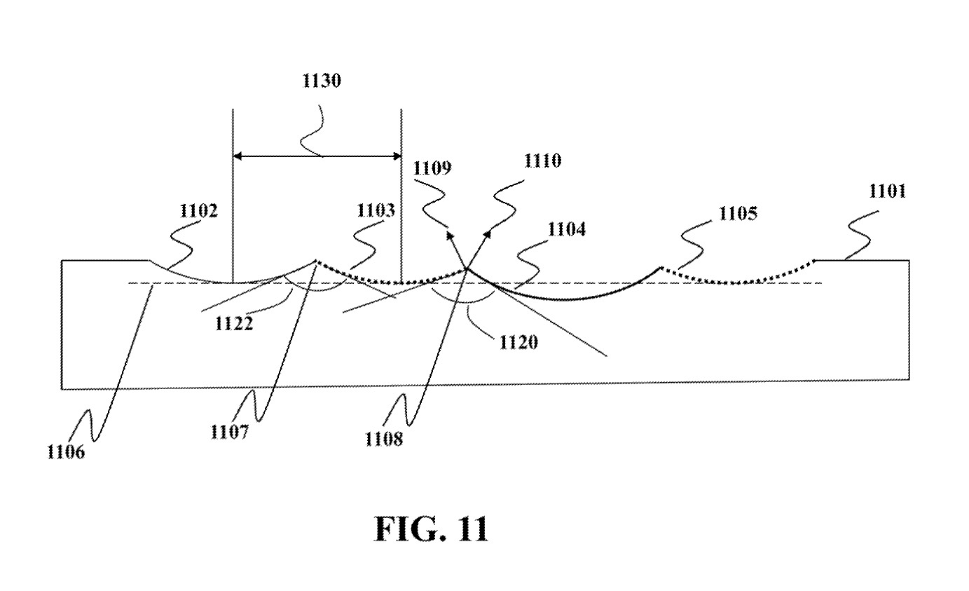

FIG. 11 is a side view of an object 1101 milled by four cuts 1102-1105 of the ball end milling cutter. The cuts 1102, 1103, and 1105 have an identical depth indicated by a dashed line 1106. However, the cut 1104 is deeper than the cuts 1102, 1103, and 1105. Each pair of the cuts meets at the cusp. For example, the cut 1102 and the cut 1103 meet at the cusp 1107; and the cut 1103 and the cut 1104 meet at the cusp 1108. Because the cut 1104 is deeper than the adjacent cuts, angle 1120 of cusp 1108 is greater than an angle 1122 of cusp 1107. A distance between adjacent cuts is a step over distance 1130, typically determined by an operator of the CAM system during generation of the machining instructions.

Some embodiments of the invention determine the orientations of the surface based on the normal vectors. As referred herein, a normal vector at a pixel has a length of one and is perpendicular to the surface at a location corresponding to the pixel. For example, referring to the FIG. 11, a vector 1109 is the normal vector associated with the cut 1103 adjacent to the cusp 1108, and a vector 1110 is the normal vector associated with the cut 1104 adjacent to the cusp 1108. The cusp angle is then determined by computing the vector dot product of the normal vectors of the surfaces on each edge of the cusp. The dot product is a cosine of the cusp angle.

Embodiments of the invention are also based on the realization that the dependency of cusp angle on cut depth is reflected in an orientation of a surface of the object and/or a model of the object rendered during the simulation. Thus, the orientation of the surface, determined by the normal vectors, and, in particularly, a rate of changes in the orientation, can be used to locate defects of the model of the object. For example, regions of the simulated surface that are less smooth can be identified and highlighted. The difficulty in this approach is that one cannot always be sure whether or not the less smooth region is necessarily a surface defect, or a design feature. This difficulty is removed by embodiments of the invention, which determine defects of a surface of an object by comparing the symmetric patterns of orientations and rate of change in the orientation. The use of normal vectors to characterize the rate of changes in the surface orientation increases the sensitivity of locating the surface defects using the surface symmetric patterns.

For example, one embodiment discloses a method for determining a defect of a surface of an object due to a machining process applied to the object, wherein the surface is generated from a model of the object by a simulation of the machining process, comprising the steps of: determining, at each pixel of the model of the surface, orientations of the surface; determining, for each pixel of the model of the surface, a rate of change in the orientations of the surface; and comparing the rate of change to at least one rate of change in a symmetric counterpart of the pixel.

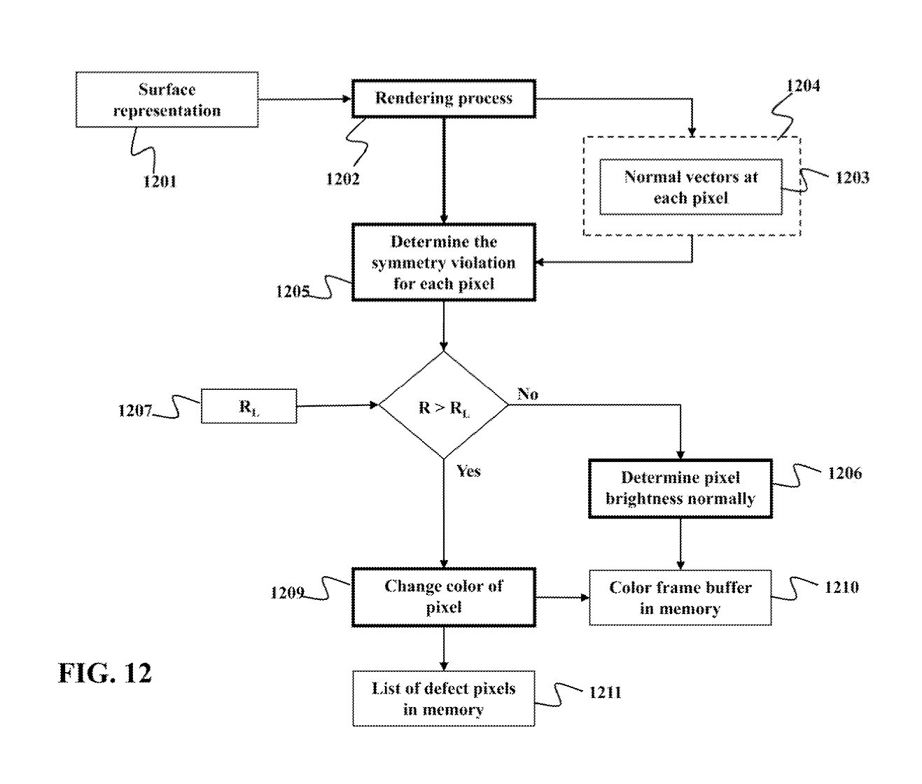

FIG. 12 shows a method for highlighting defects of the surface of the model of the object while rendering the surface of the object on a display device. The rendering 1202 of the simulated surface of the object depends in the underlying representation of the surface 1201. For example, the surface may be represented by a Boolean difference between distance fields that represent an original surface, and distance fields that represent the volume traversed by the machining tool during the cutting.

In one embodiment, the surface is rendered by a ray casting method where virtual rays associated with each pixel are projected onto the simulated surface from a viewing direction. The color and brightness of each ray that intersects the surface is determined by a surface color and the normal vector at a point of intersection.

Another example of a representation of the surface 1201 is a mesh of geometric primitives such as polygons. In one embodiment, a triangle mesh is rendered using a graphics application programming interface (API) such as OpenGL. Usually the color and the normal vector are defined at each vertex of a triangle interpolated by the graphics implementation across the pixels spanned by the triangle according to viewing conditions.

The normal vectors are used to compute the brightness of the pixel as though the surface was lit by a light arranged above the surface. As an example, one computer lighting technique determines the brightness of the pixel as a sum of an ambient component independent of the normal vectors, a diffuse component proportional to the vector dot product between the normal vector and a vector from the surface to the light position, and a specular component proportional to the dot product between the surface normal vector and a vector halfway between the viewing direction and the light direction, raised to a power determined by a reflection of the surface.

Usually, the normal vector for each pixel in the image of the surface is used to compute the brightness of the pixel, and then discarded. The resultant pixel values are stored in a memory called a color frame buffer, and can be displayed, stored, or transmitted.

One embodiment of the invention reuses the normal vectors for representing the surface, instead of discarding the normal vectors determined to compute the brightness of the pixels. In this embodiment, instead of immediately computing the pixel brightness using the normal vectors, the normal vectors 1203 for every pixel in the image of the surface are stored into a normal frame buffer 1204. After all of the normal vectors have been stored, the normal vectors are processed to identify and/or highlight defects, using the information about the surface symmetry patterns, which the normal vectors must follow.

In one embodiment, the symmetry violations R are detected based on differences 1205 between the actual normal vector at the given pixel and the normal vector(s) at the pixel symmetric representation. The regions of the surface with the symmetry violation values below the minimal threshold R_{L} 1207 are free of defects. Some embodiments change 1209 colors of pixels, e.g., in a red color, in the detect range, while colors of other pixels are computed normally 1206 using the values stored in the normal framebuffer. After the pixels corresponding to the defect regions are determined, the pixels can he stored in the memory 1211 and the colors of those pixels can be stored in the color frame buffer 1210.

Another embodiment generates a list of possible defect areas on the simulated surface, and outputs this list to the user. For example, the list can be presented as rectangular boxes superimposed on the low resolution image and enclosing the possible defect regions. The operator can then view these regions more closely to make a final determination as to the existence of an actual defect. Additionally or alternatively, the defect list is presented in a text format describing location and character of the possible defect. It is advantageous to use a user interface such that the user can selects an entry in the defect list to have the simulated image reorient, center and zoom into the defect region.

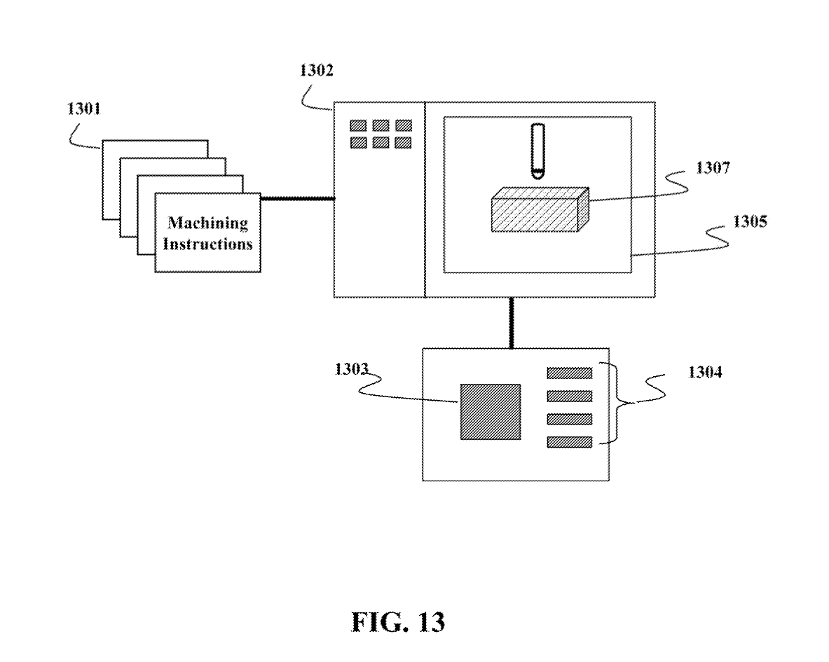

FIG. 13 shows an example of another embodiment of the invention. A set of machining instructions 1301 is provided to an NC machining simulator 1302 either as a file over a network, or by other means known in the art. The simulator 1302 includes of a processor 1303, memory 1304 and a display 1305 for showing the operation of the machine. The processor performs a machining simulation and executes a method according to embodiments of the invention to determine the defect and to produce an image 1307 identifying the defects of the machining simulation on the display device 1305.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for determining a defect on a surface of an object, comprising:
generating a symmetric representation of at least part of the object;
determining a pair of unmatched areas between the surface of the object and a surface of the symmetric representation; and
determining the defect on the surface of the object based on the pair of unmatched areas, wherein steps of the method are performed by a processor.

2. The method of claim 1, wherein the part of the object is symmetric, further comprising:
segmenting the object into a plurality of parts including the symmetric part.

3. The method of claim 1, further comprising:
determining the symmetric representation based on a symmetry of the object.

4. The method of claim 1, further comprising:
modifying a color of each pixel of the unmatched areas; and
rendering a model of the object on a display device.

5. The method of claim 1, wherein the symmetric representation is a first symmetric representation, and the pair of unmatched areas is a first pair of unmatched areas, further comprising:
generating a second symmetric representation of the part of the object;
determining a second pair of unmatched areas between the surface of the object and a corresponding surface of the second symmetric representation; and
comparing the first pair of unmatched areas with the second pair of unmatched areas to determine a common unmatched area corresponding to the defect.

6. The method of claim 5, wherein the comparing comprises:
determining an unmatched area on the surface of the first symmetric representation and on the surface of the second symmetric representation.

7. The method of claim 5, further comprising:
generating a model of the object without the defect on the surface.

8. The method of claim 7, further comprising:
modifying the model of the object based on a common difference between the surface of the object and surfaces of the first and the second symmetric representations of the object.

9. The method of claim 5, further comprising:
modifying a color of each pixel of the common unmatched area; and
rendering a model of the object on a display.

10. The method of claim 1, further comprising:
comparing normal vectors to the surface of the object with normal vectors to the surface of the symmetric representation to determine the unmatched areas.

11. The method of claim 1, further comprising:
comparing a rate of change of normal vectors to the surface of the object with a rate of change of normal vectors to the surface of the symmetric representation to determine the unmatched areas.

12. The method of claim 1, further comprising:
segmenting a model of the object into a set of mutually symmetric parts including a first mutually symmetric part and a second mutually symmetric part;
determining the part of the object as the first mutually symmetric part; and
determining the symmetric representation of the part of the object as the second mutually symmetric part.

13. The method of claim 1, further comprising:
simulating machining of the object to determine the surface of the object, wherein the defect of the surface of the object is due to the simulating.

14. A method for determining a defect of a surface of an object due to machining the object, wherein the surface is generated from a model of the object by a simulation of the machining, comprising steps of:
generating a first symmetric representation of a part of the surface;
generating a second symmetric representation of the part of the surface, wherein the first and the second symmetric representations are mutually symmetric; and
determining the defect as a common difference between the surface of the object with the first symmetric representation and the second symmetric representation, wherein steps of the method are performed by a processor.

15. A system for determining a defect of a surface of an object due to machining the object, wherein the surface is generated from a model of the object by a simulation of the machining process, comprising:
a processor for determining the defect based on a comparison of the surface of the object with a surface of a symmetric representation of the object.

16. The system of claim 15, further comprising:
a display device for displaying the model of the object, wherein the processor highlights each pixel corresponding to an area of the defect.

17. The system of claim 15, wherein the processor generates a first symmetric representation and a second symmetric representation of a part of the surface, and determines the defect as a common difference between the surface of the object with the first second symmetric representation and the second symmetric representation.
